(19) United States
(12) Patent Application Publication
(10) Pub. No.: US 2026/0070775 A1
(43) Pub. Date: Mar. 12, 2026

(54) BODY FOR COLD DRINK DISPENSER

(71) Applicant: Guangzhou Xin'an Trading Co., Ltd., Guangzhou (CN)

(72) Inventor: Quan Zhou, Guangzhou (CN)

(21) Appl. No.: 19/017,837

(22) Filed: Jan. 13, 2025

(30) Foreign Application Priority Data
Sep. 6, 2024 (CN) 202422200739.9

(51) Int. Cl. B67D 1/08

(52) U.S. Cl. CPC B67D 1/0889; B67D 1/0857; B67D 2210/00031

(57) ABSTRACT

The disclosure relates to the technical field of a cold drink dispenser, particularly to a body for a cold drink dispenser, comprising a base and a cold drink dispenser assembly detachably connected thereto, the cold drink dispenser assembly comprises a compressor, a heat dissipation mechanism, and a frame assembly; the base comprises a first area for placing the compressor and a second area for placing the heat dissipation mechanism; the front side and the rear side of the first area are both provided with a first fixing seat for fixing the compressor, and the left side and the right side of the first area are both provided with a positioning member for positioning the compressor; the base is provided with a second fixing seat for fixing the frame assembly. By adopting the cold drink dispenser, the problems of inconvenient maintenance and unstable connection can be solved.

### CROSS REFERENCE TO RELATED APPLICATIONS

The present application claims the benefit of Chinese Patent Application No. 202422200739.9 filed on Sep. 6, 2024, the contents of which are incorporated herein by reference in their entirety.

### TECHNICAL FIELD

This application relates to the technical field of a cold drink dispenser device, particularly to a body for a cold drink dispenser.

### BACKGROUND

In the contemporary catering and beverage production industry, cold drink dispensers are highly favored for their ability to quickly mix ice cubes with various ingredients to make cold drinks. However, existing cold drink dispenser designs have some shortcomings that not only degrade the user experience but may also lead to safety accidents.

Currently, the connection methods between the components of cold drink dispensers are not convenient, especially when assembly and disassembly operations are required, making daily cleaning and maintenance cumbersome and thus increasing maintenance costs.

Moreover, the main bodies of cold drink dispensers are often fixed using simple latches or bolts, which can easily loosen during operation, potentially causing accidental opening.

Therefore, there is an urgent need to design a body for a cold drink dispenser to address the aforementioned issues.

### SUMMARY

The technical problem to be solved by this application is to provide a body for a cold drink dispenser that can address the issues of inconvenient maintenance and unstable connections in the prior art.

To solve the aforementioned technical problem, this application provides a body for a cold drink dispenser, comprising a base and a cold drink dispenser assembly detachably connected to the base. The cold drink dispenser assembly comprises a compressor, a heat dissipation mechanism, and a frame assembly. The base comprises a first area for accommodating the compressor and a second area for accommodating the heat dissipation mechanism. The front and rear sides of the first area are provided with first fixing seats for securing the compressor, while the left and right sides of the first area are provided with positioning members for locating the compressor. The base is further provided with second fixing seats for fixing the frame assembly.

As an improvement to the aforementioned solution, the compressor is provided with four fixing handles, and each fixing handle has a handle opening.

As another improvement, the center of the first fixing seat is provided with a first fixing hole, and an annular ring surrounds the first fixing hole. Reinforcement strips are provided between the first fixing hole and the annular ring. The fixing handle is placed on the first fixing seat, with the compressor abutting against the positioning member. The handle opening aligns with the first fixing hole, and a fixing part is passed through the first fixing hole and the handle opening to fix the fixing handle to the first fixing seat.

As a further improvement, the cold drink dispenser assembly also comprises an upper mechanism disposed above the frame assembly. The frame assembly comprises at least two frames, each frame having a top surface for supporting the upper mechanism and standing feet disposed at both ends of the top surface.

As another enhancement, the bottom of the standing feet is provided with a foot portion, and the center of the foot portion has a foot hole. The top surface is provided with top positioning holes and top fixing holes. The upper mechanism is provided with mechanism positioning shafts and mechanism fixing holes corresponding to the top positioning holes and top fixing holes, respectively. The mechanism positioning shafts are inserted into the top positioning holes, and the mechanism fixing holes align with the top fixing holes. Fixing parts are passed through the top fixing holes and the mechanism fixing holes to fix the upper mechanism to the top surface.

As an additional improvement, the center of the second fixing seat has a second fixing hole. The foot portion is placed in the second fixing seat, with the foot hole aligning with the second fixing hole. Finally, a fixing part is passed through the second fixing hole and the foot hole to fix the foot portion to the second fixing seat.

As another refinement, both the first area and the second area are provided with frames, and the frame disposed in the second area is provided with support members and at least two side fixing holes.

As a further enhancement, the heat dissipation mechanism comprises a heat dissipation tube assembly and an exhaust fan connected to the front side of the heat dissipation tube assembly. The exhaust fan is located within the frame of the second area. The heat dissipation tube assembly has connecting parts supported above the support members, with the connecting parts disposed outside the standing feet. The connecting parts have connecting fixing holes corresponding to the side fixing holes. The connecting fixing holes align with the side fixing holes, and fixing parts are passed through the connecting fixing holes and the side fixing holes to fix the connecting parts to the standing feet.

As another improvement, the second area is provided with a fixing groove and a fixing plate for securing a power cord. The power cord is placed in the fixing groove, and the fixing plate is bolted over the fixing groove.

As another improvement, both the first area and the second area are provided with several reinforcement strips.

The beneficial effects of implementing this application lie in as follows.

The body for the cold drink dispenser in this application accommodates the compressor and the heat dissipation mechanism separately through the first area and the second area, respectively. The compressor is fixed by the first mounting bracket in conjunction with the positioning member, allowing the compressor and the heat dissipation mechanism to be placed apart for easier management and maintenance.

The body for the cold drink dispenser in this application positions the compressor via the positioning member. The first fixing hole of the first mounting bracket aligns with the handle opening of the fixing handle to fix the compressor using fixing parts. Meanwhile, the second fixing hole of the second mounting bracket aligns with the foot hole of the leg part to stabilize the frame connection using fixing parts.

### BRIEF DESCRIPTION OF DRAWINGS

FIG. 1 is a three-dimensional structural diagram of the body of the cold drink dispenser in this application;

FIG. 2 is a structural diagram of the pedestal in the body of the cold drink dispenser in this application;

FIG. 3 is a three-dimensional structural diagram of the body of the cold drink dispenser in this application after removing the upper mechanism;

FIG. 4 is a structural diagram of the separation of the upper mechanism and the frame in the body of the cold drink dispenser in this application;

FIG. 5 is an enlarged view of part A corresponding to FIG. 4.

### DESCRIPTION OF EMBODIMENTS

To make the purpose, technical solutions, and advantages of this application clearer, a further detailed description of this application will be provided below in conjunction with the accompanying drawings. It is hereby declared that the directional terms such as up, down, left, right, front, rear, inside, and outside appearing or soon to appear in the text are solely based on the accompanying drawings of this application and do not constitute specific limitations on this application.

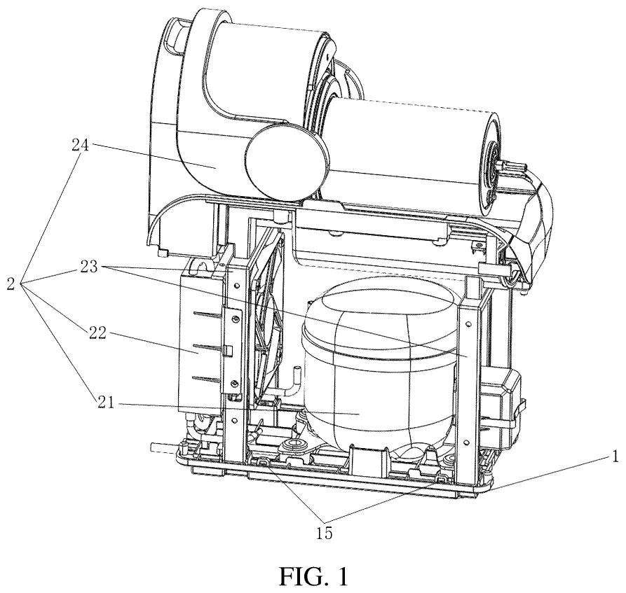

As shown in FIGS. 1 to 3, the body of the cold drink dispenser in this application comprises a base 1 and a cold drink dispenser assembly 2 detachably connected to the base 1. The cold drink dispenser assembly 2 comprises a compressor 21, a heat dissipation mechanism 22, and a frame assembly 23.

The base 1 comprises a first area 11 for accommodating the compressor 21 and a second area 12 for accommodating the heat dissipation mechanism 22, with the second area 12 located at the rear of the first area 11.

The front and rear sides of the first area 11 are each provided with a first mounting bracket 111 for fixing the compressor 21, and the left and right sides of the first area 11 are each provided with a positioning member 112 for positioning the compressor 21.

The base 1 is also provided with a second mounting bracket 13 for fixing the frame assembly 23. Preferably, the base 1 is provided with auxiliary holes 15, which can be used with cable ties to secure internal wires.

The compressor 21 is provided with four fixing handles 211, each with a handle opening 211a.

The center of the first mounting bracket 111 is provided with a first fixing hole 111a, surrounded by an annular ring 111b. Reinforcement strips 111c are provided between the first fixing hole 111a and the annular ring 111b.

The fixed handle 211 is placed on the first fixing seat 111, and the compressor 21 abuts against the positioning part 112. Preferably, an anti-vibration pad is provided between the compressor 21 and the positioning part 112. The handle opening 211a aligns with the first fixing hole 111a, and fixing parts are passed through the first fixing hole 111a and the handle opening 211a to fix the fixed handle 211 to the first fixing seat 111. Preferably, the fixing parts are bolts and nuts, with the bolt passing sequentially through the bottom of the base 1, the first fixing hole 111a, the handle opening 211a, and the nut. A washer is placed between the nut and the handle opening 211a.

The second area 12 is provided with a fixing groove 121 and a fixing plate 122 for securing the power cord. The power cord is placed in the fixing groove 121, and the fixing plate 122 covers the fixing groove 121 and is connected via bolts.

To enhance the strength of the base 1, both the first area 11 and the second area 12 are provided with several reinforcement strips 14. Between these reinforcement strips 14, exhaust holes may be provided for heat dissipation.

The cold drink dispenser assembly 2 also comprises an upper mechanism 24 positioned above the frame set 23. The frame set 23 comprises at least two frames 231, each including a top surface 231a for supporting the upper mechanism 24 and standing feet 231b located at both ends of the top surface 231a.

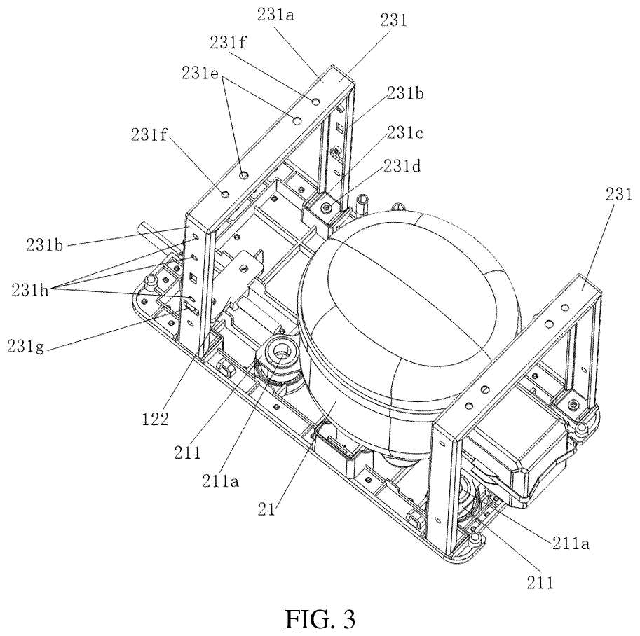

As shown in FIGS. 3 to 5, the bottom of the standing feet 231b is provided with support legs 231c, and the center of the support legs 231c has support leg holes 231d. The top surface 231a is provided with top positioning holes 231e and top fixing holes 231f.

The upper mechanism 24 is provided with mechanism positioning shafts 241 and mechanism fixing holes 242 that correspond to the top positioning holes 231e and top fixing holes 231f, respectively.

The mechanism positioning shafts 241 are inserted into the top positioning holes 231e, and the mechanism fixing holes 242 align with the top fixing holes 231f. Fixing parts are passed through the top fixing holes 231f and the mechanism fixing holes 242 to fix the upper mechanism 24 to the top surface 231a. Preferably, the fixing parts are bolts, and the mechanism fixing holes 242 are threaded holes. The fixing parts are passed through the top fixing holes 231e from the bottom of the top surface 231a and threaded into the mechanism fixing holes 242 to secure the upper mechanism 24 to the top surface 231a.

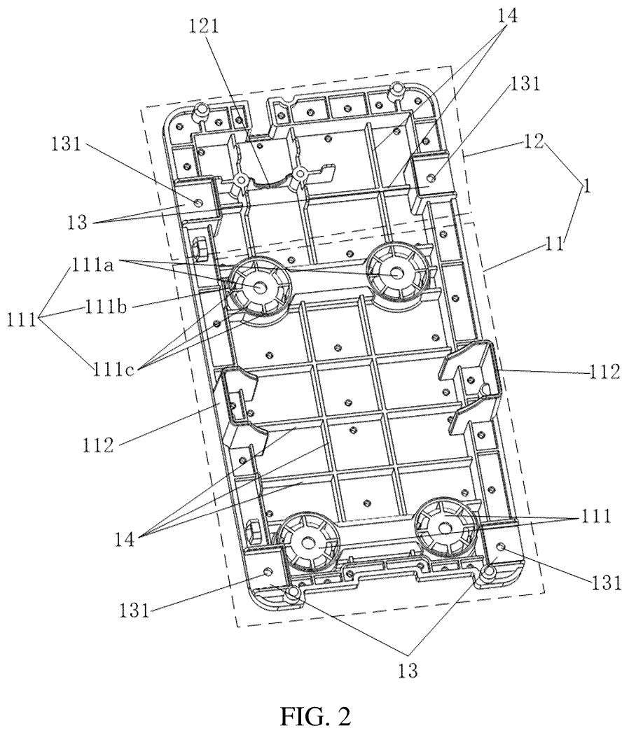

As shown in FIGS. 2 and 3, the center of the second fixing seat 13 is provided with a second fixing hole 131.

The support legs 231c are inserted into the second fixing seat 13, and the support leg holes 231d align with the second fixing hole 131. Finally, fixing parts are passed through the second fixing hole 131 and the support leg holes 231d to fix the support legs 231c to the second fixing seat 13. Preferably, the fixing parts are bolts, and the support leg holes 231d are threaded holes. The fixing parts are passed through the second fixing hole 131 from the bottom of the base 1 and threaded into the support leg holes 231d to secure the support legs 231c to the second fixing seat 13.

Both the first area 11 and the second area 12 are provided with the frames 231. The frame 231 located in the second area 12 is provided with support members 231g and at least two side fixing holes 231h.

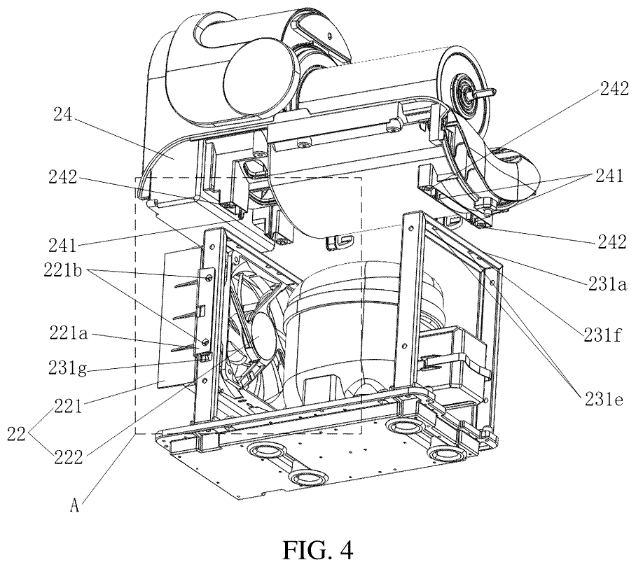

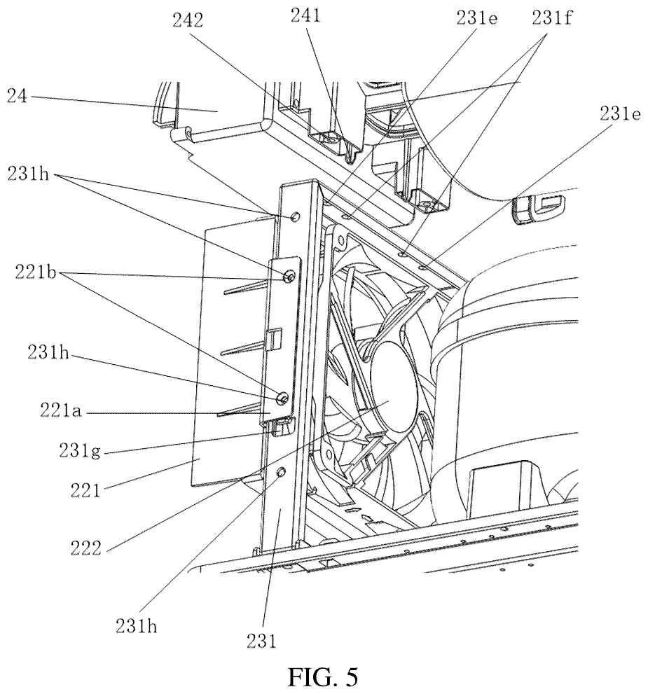

As shown in FIGS. 4 and 5, the heat dissipation mechanism 22 comprises a heat dissipation tube assembly 221 and an exhaust fan 222 connected to the front side of the heat dissipation tube assembly 221. The exhaust fan 222 is positioned within the frame 231 of the second area 12 to minimize the use of internal space.

The heat dissipation tube assembly 221 is provided with connecting parts 221a supported above the support members 231g. The connecting parts 221a are located outside the standing feet 231b and are provided with connecting fixing holes 221b corresponding to the side fixing holes 231h.

The connecting fixing holes 221b align with the side fixing holes 231h, and fixing parts are passed through the connecting fixing holes 221b and the side fixing holes 231h to fix the connecting parts 221a to the standing feet 231b. Preferably, the fixing parts are bolts. There are two connecting fixing holes 221b and four side fixing holes 231h. Two of the side fixing holes 231h, corresponding to the two connecting fixing holes 221b, are threaded holes. The fixing parts are passed through the connecting fixing holes 221b and threaded into these side fixing holes 231h to secure the connecting parts 221a to the standing feet 231b. The remaining two side fixing holes 231h can be used with cable ties to fix internal wires.

In summary, the body for the cold drink dispenser of this application accommodates the compressor 21 and the heat dissipation mechanism 22 in the first area 11 and the second area 12, respectively. The compressor 21 is fixed by the first fixing seat 111 in conjunction with the positioning part 112, separating the compressor 21 and the heat dissipation mechanism 22 for easy management and maintenance. The first fixing hole 111a of the first fixing seat 111 cooperates with the handle opening 211a of the fixed handle 211 to fix the compressor 21 with fixing parts. The second fixing hole 131 of the second fixing seat 13 cooperates with the support leg holes 231d of the support legs 231c to fix the frame 231 with fixing parts. The upper mechanism 24 is positioned by inserting the mechanism positioning shafts 241 into the top positioning holes 231e, aligning the mechanism fixing holes 242 with the top fixing holes 231f, and then securing them with fixing parts. The overall connection is stable.

The above description is the preferred embodiment of this application. It should be noted that ordinary technicians in this technical field can make several improvements and modifications without departing from the principles of this application. These improvements and modifications are also considered within the scope of protection of this application.

What is claimed is:

1. A body for a cold drink dispenser, comprising a base and a cold drink dispenser assembly detachably connected to the base, wherein the cold drink dispenser assembly comprises a compressor, a heat dissipation mechanism, and a frame assembly;
wherein the base comprises a first area for accommodating the compressor and a second area for accommodating the heat dissipation mechanism;
wherein the front and rear sides of the first area are both provided with first fixing seats for fixing the compressor, and the left and right sides of the first area are both provided with positioning parts for positioning the compressor;
the base is provided with a second fixing seat for fixing the frame assembly.

2. The body for the cold drink dispenser according to claim 1, wherein the compressor is provided with four fixed handles with handle openings.

3. The body for the cold drink dispenser according to claim 2, wherein the center of the first fixing seat is provided with a first fixing hole, the exterior of the first fixing hole is provided with an annular ring surrounding the first fixing hole, and a reinforcement strip is provided between the first fixing hole and the annular ring;
the fixed handle is disposed on the first fixing seat, the compressor abuts against the positioning part, the handle opening aligns with the first fixing hole, and a fixing part is passed through the first fixing hole and the handle opening to fix the fixed handle to the first fixing seat.

4. The body for the cold drink dispenser according to claim 1, wherein the cold drink dispenser assembly further comprises an upper mechanism disposed above the frame assembly, the frame assembly comprises at least two frames, and each frame comprises a top surface for supporting the upper mechanism and standing feet disposed at both ends of the top surface.

5. The body for the cold drink dispenser according to claim 4, wherein the bottom of the standing feet is provided with support legs, the center of the support legs is provided with support leg holes, and the top surface is provided with top positioning holes and top fixing holes;
the upper mechanism is provided with mechanism positioning shafts and mechanism fixing holes corresponding to the top positioning holes and top fixing holes, respectively;
the mechanism positioning shafts are inserted into the top positioning holes, the mechanism fixing holes align with the top fixing holes, and fixing parts are passed through the top fixing holes and the mechanism fixing holes to fix the upper mechanism to the top surface.

6. The body for the cold drink dispenser according to claim 5, wherein the center of the second fixing seat is provided with a second fixing hole;
the support legs are inserted into the second fixing seat, the support leg holes align with the second fixing hole, and finally, fixing parts are passed through the second fixing hole and the support leg holes to fix the support legs to the second fixing seat.

7. The body for the cold drink dispenser according to claim 5, wherein both the first area and the second area are provided with the frames, and the frame disposed in the second area is provided with support members and at least two side fixing holes.

8. The body for the cold drink dispenser according to claim 7, wherein the heat dissipation mechanism comprises a heat dissipation tube assembly and an exhaust fan connected to the front side of the heat dissipation tube assembly, the exhaust fan is located within the frame of the second area;
the heat dissipation tube assembly is provided with connecting parts supported above the support members, the connecting parts are disposed outside the standing feet, and the connecting parts are provided with connecting fixing holes corresponding to the side fixing holes;
the connecting fixing holes align with the side fixing holes, and fixing parts are passed through the connecting fixing holes and the side fixing holes to fix the connecting parts to the standing feet.

9. The body for the cold drink dispenser according to claim 1, wherein that the second area is provided with a fixing groove and a fixing plate for fixing a power cord, the power cord is disposed in the fixing groove, and the fixing plate is connected to the fixing groove by bolts and covers it.

10. The body for the cold drink dispenser according to claim 1, wherein a plurality of reinforcement strips are provided in both the first area and the second area.
